(19) United States
(12) Patent Application Publication
(10) Pub. No.: US 2019/0201176 A1
(43) Pub. Date: Jul. 4, 2019

(54) CURING LIGHT DEVICE ASSEMBLY

(71) Applicant: Garrison Dental Solutions, LLC, Spring Lake, MI (US)

(72) Inventor: Steven H. Peterson, Martin, MI (US)

(21) Appl. No.: 15/932,452

(22) Filed: Jun. 9, 2017

(51) Int. Cl. A61C 13/15; H05B 33/08; F21V 7/00

(52) U.S. Cl. CPC A61C 19/004; F21Y 2115/10; F21V 7/0075; H05B 33/0893

(57) ABSTRACT

A curing light assembly includes a housing, a base for supporting the housing in a storage position, a light source supported by the housing, and a controller configured to operate the light source. The light assembly further includes a light sensor in communication with the controller, which light sensor is operable to detect light emitted from the light source when the housing is supported in the storage position, and with the controller configured to calibrate the light source based on light detected by the light sensor from the light source when the housing is supported in the storage position.

### TECHNICAL FIELD AND BACKGROUND OF THE DISCLOSURE

The present disclosure relates to a curing light device, and more specifically to a curing light device that may be used to cure dental composites.

Dental curing LED light devices used to cross-polymerize (i.e. harden) the resin used in modern composite fillings for teeth have been received with much success. With the advancements in LED technology, the power output from curing light devices has increased over the years. While an optical power of about 200 to 300 mW/cm² was typical a decade ago, the power associated with current designs often exceeds 2000 mw/cm².

With the ensuing trend toward much higher power dental curing lights, intended to solve various issues of “under cure” and also to greatly reduce the time required to achieve full cure of a placed composite filling, several temperature related challenges have become prevalent. First, all LED lights decay over time and, therefore, even when higher power LEDs are available the amount of heat delivered to the tooth may not be easily predicted or accurate. With more powerful LEDs the need for greater accuracy is more important because there is a tendency by some to overcompensate when the proper curing is not first achieved—and with more powerful LEDs, overcompensation could elevate the temperature of the treated tooth to an undesired level, which can harm the vitality of the tooth pulp. In some cases, there is the possibility due to misalignment of the curing light the elevated temperatures can cause unintended direct exposure of tongue, cheek, or gingival tissues that in turn can cause painful and in some cases, severe, burns to those irradiated tissues.

Accordingly, there is a need for a dental curing light device that can offer greater control and accuracy over their power output.

### SUMMARY

In one embodiment, a curing light assembly includes a housing, a base for supporting said housing in a storage position, and a light source supported by said housing. The curing light assembly further includes a controller configured to operate said light source and a sensor in communication with the controller. The sensor is operable to detect light emitted from said light source when said housing is supported in said storage position. And, the controller is configured to calibrate said light source based on light detected by said sensor.

In one aspect, the sensor is supported by said housing. And, the sensor is operable to detect a reflection of light emitted from said light source.

In a further aspect, the base is configured to support said curing light assembly on a surface. The sensor is operable to detect a reflection of light emitted from said light source from the surface.

In another aspect, the base includes a reflective surface, and said sensor is operable to detect a reflection of light emitted from said light source from said reflective surface.

In any of the above, the controller may be supported in said housing.

In any of the above, the curing light assembly further includes an actuatable input device in communication with said controller. The controller is configured to initiate calibration of said light source in response to actuation of said actuatable input device.

For example, the actuatable input device may comprise a user actuatable input device, such as a user actuatable switch.

In any of the above, the actuatable input device may be supported by said housing or said base. For example, the actuatable input device may comprise a sensor, including a sensor for detecting when said housing is supported in said storage position.

In one embodiment, the actuatable input device is supported by a handheld remote control device that generates a remote control signal to the controller to initiate the calibration of the light source using the signals from the light sensor.

In yet another embodiment, a method of calibrating a curing light device includes the steps of locating the curing light device in a storage position, powering the light source to emit light when the curing light device is in the storage position, and calibrating the light source based on the light emitted from the light source of the curing light device when the curing light device is in the storage position.

In one aspect, powering the light source includes powering the light source in response to a signal.

For example, powering the light source in response to a signal may include powering the light source in response a signal from a sensor or a switch.

Accordingly, the curing light device assembly may provide a closed loop feedback or open loop calibration process

### DETAILED DESCRIPTION OF THE FIGURES

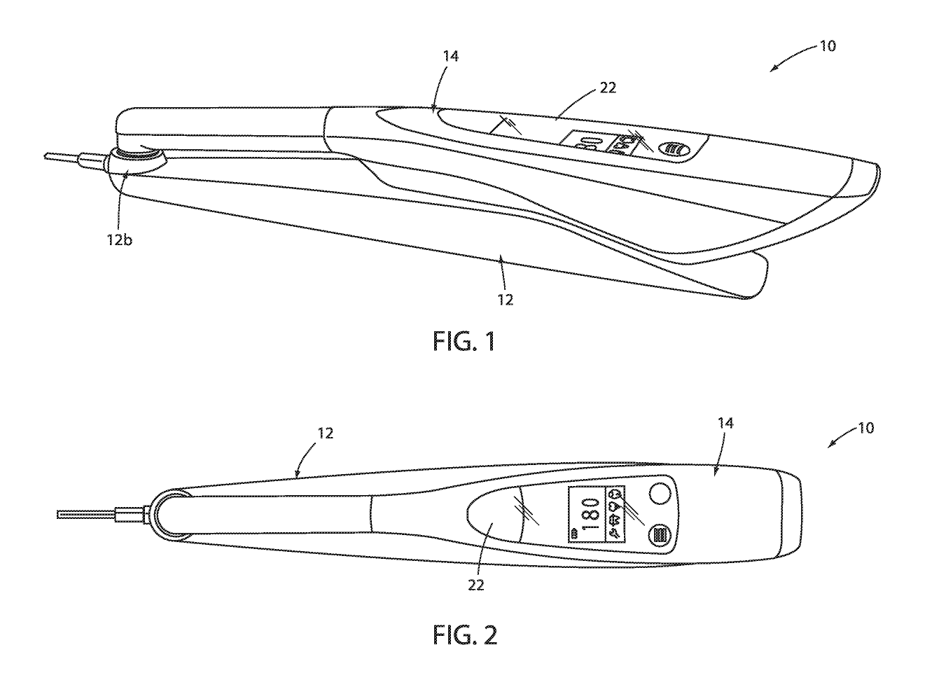

FIG. 1 is a perspective view of a curing light device assembly with a curing light device supported and located in a storage position on a base;

FIG. 2 is a top plan view of the curing light device assembly of FIG. 1;

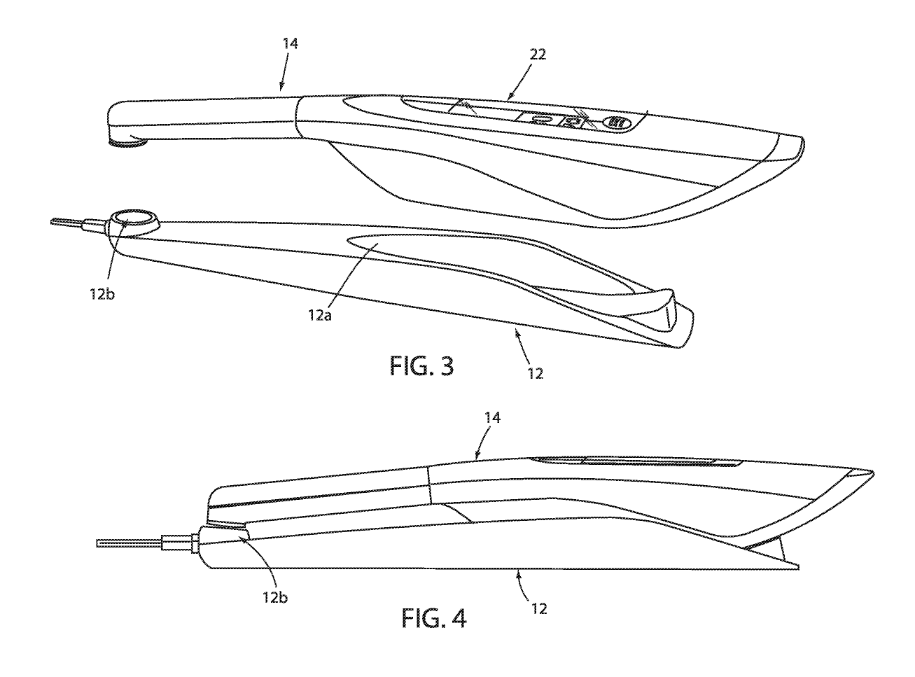

FIG. 3 is an exploded perspective view of the curing light device assembly of FIG. 1;

FIG. 4 is a side elevation view of the curing light device assembly of FIG. 1;

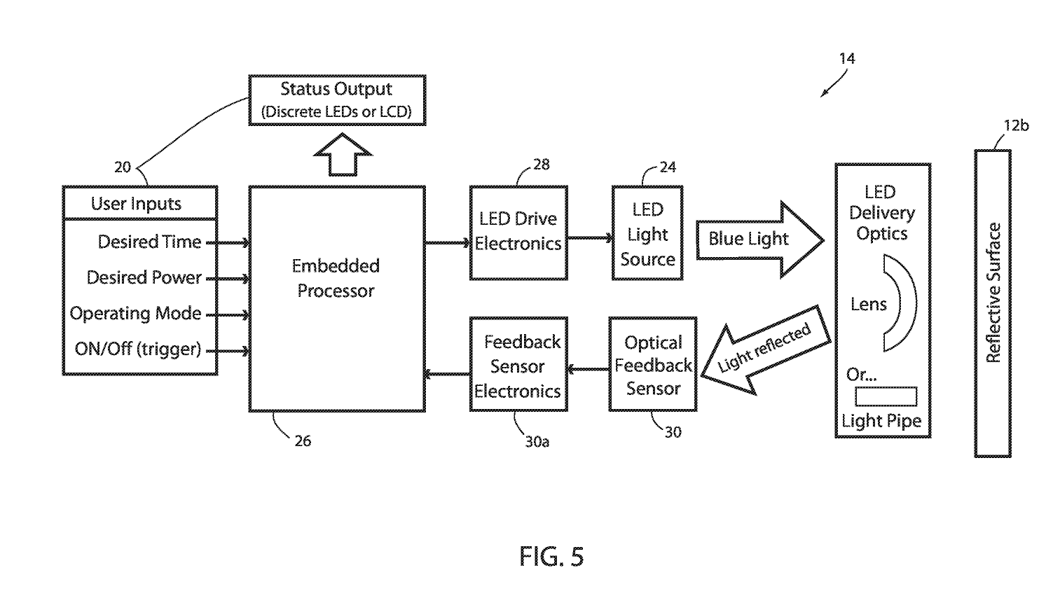

FIG. 5 is a schematic drawing of the control circuitry for the curing light device;

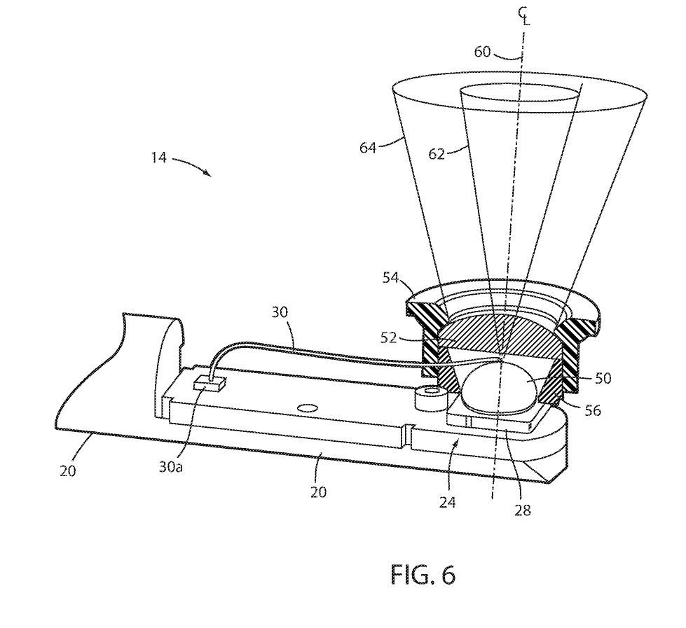

FIG. 6 is an enlarged partial fragmentary side elevation view of the curing light device;

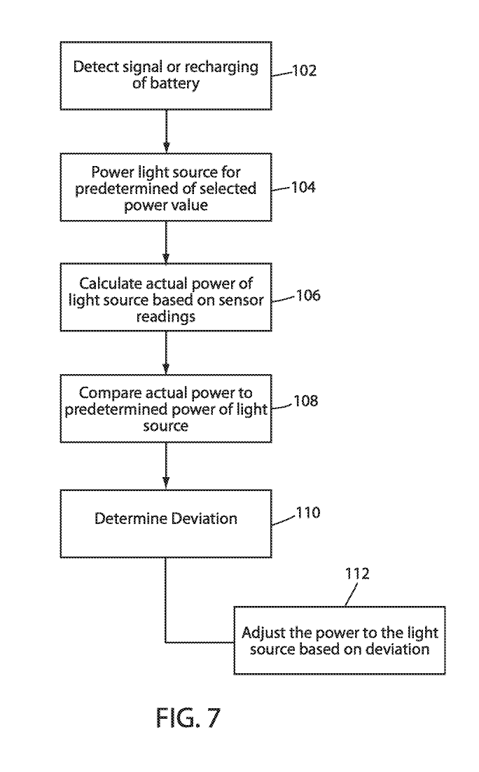

FIG. 7 is a flowchart of the calibration process that may be used with the curing light assembly;

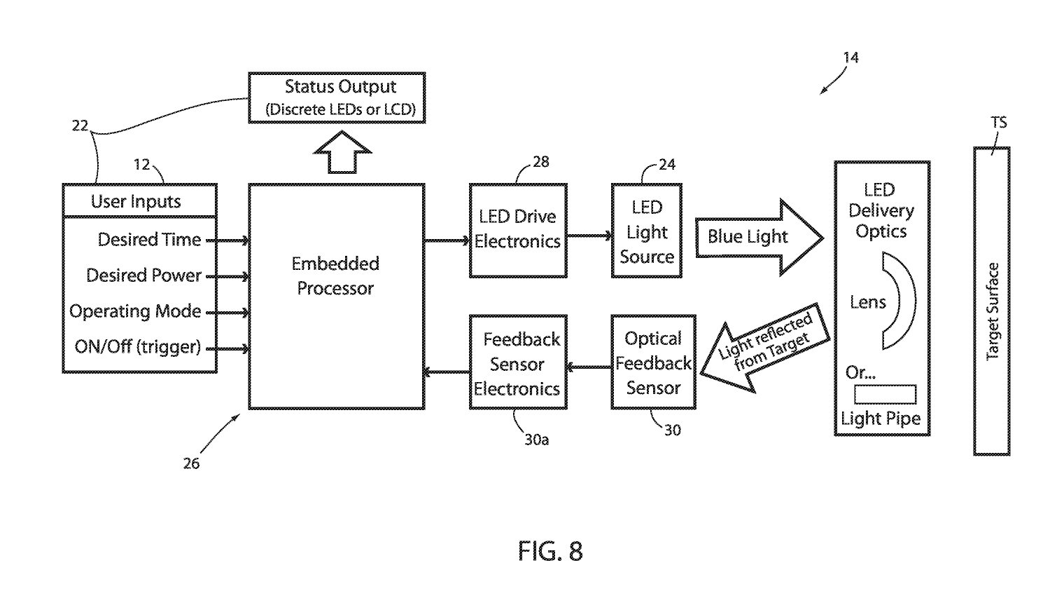

FIG. 8 is a schematic drawing of another embodiment of the control circuitry for the curing light device;

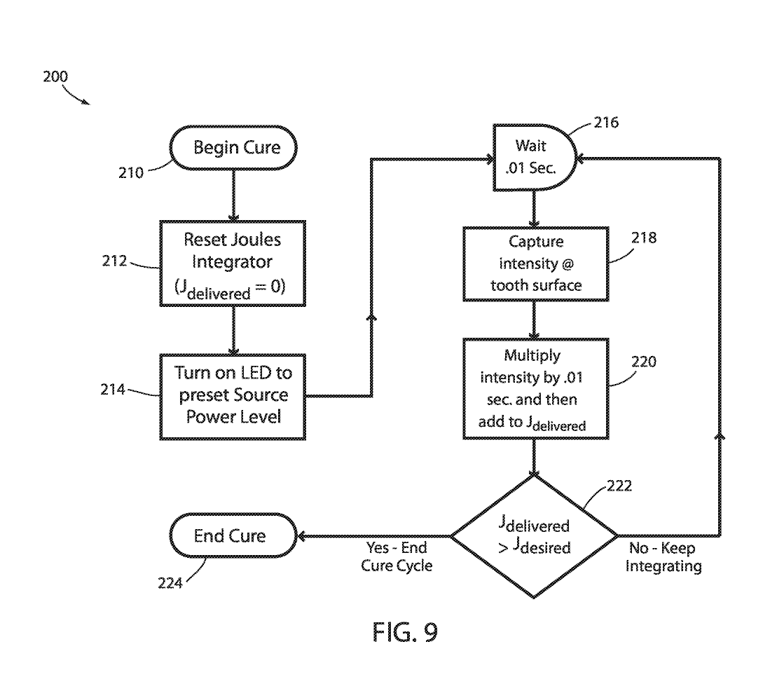

FIG. 9 is a flowchart of a closed loop feedback control that may be used with the curing light assembly;

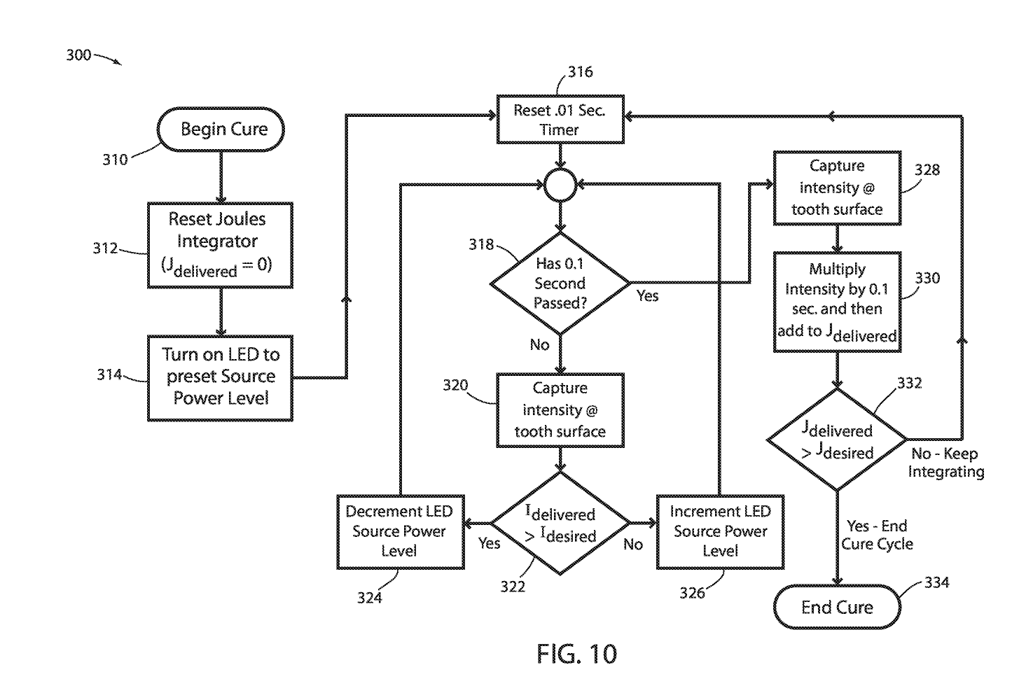

FIG. 10 is a flowchart of another embodiment of a closed loop feedback control that may be used with the curing light assembly;

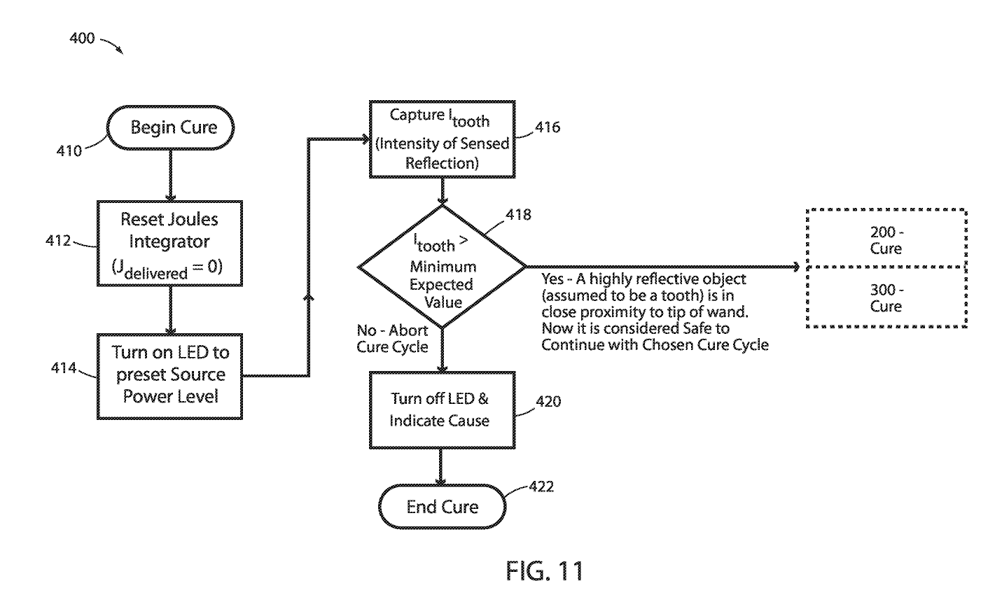

FIG. 11 is a flowchart of third embodiment of a closed loop feedback control that may be used with the curing light assembly;

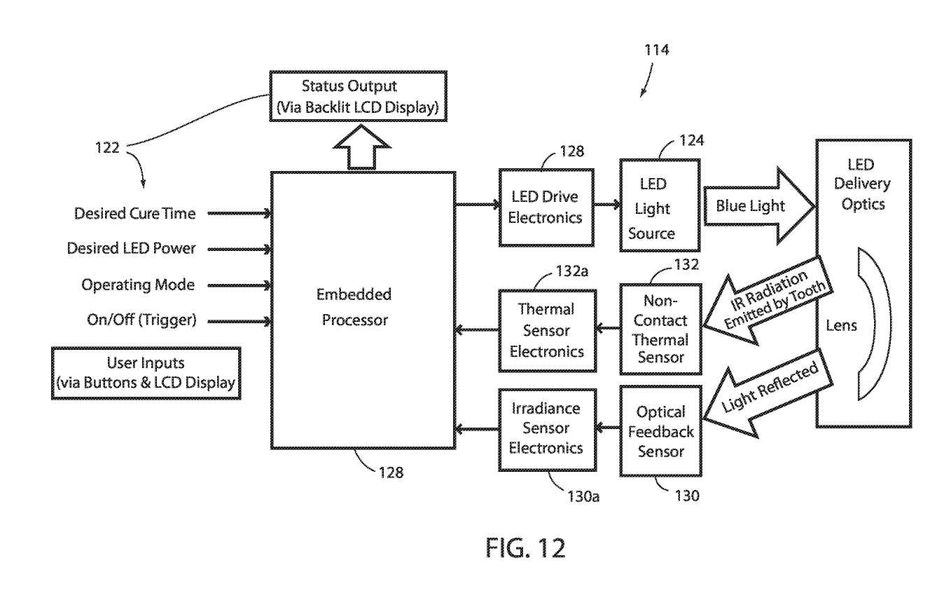

FIG. 12 is a schematic drawing of another embodiment of a curing light device;

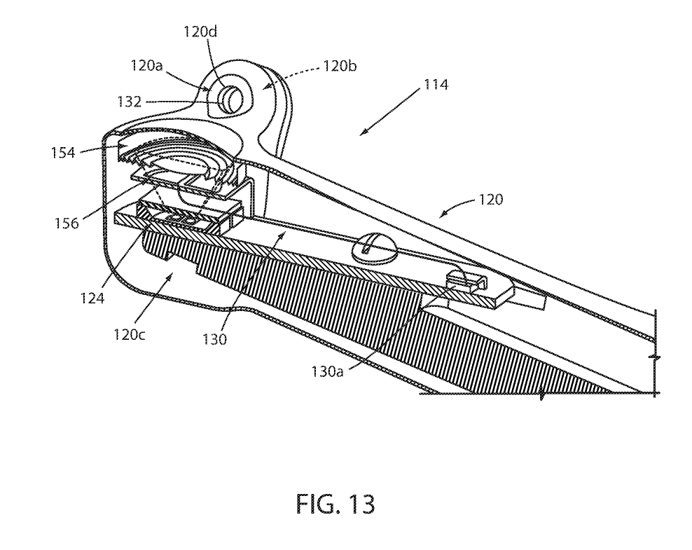

FIG. 13 is an enlarged partial fragmentary side elevation view of the curing light device of FIG. 12; and

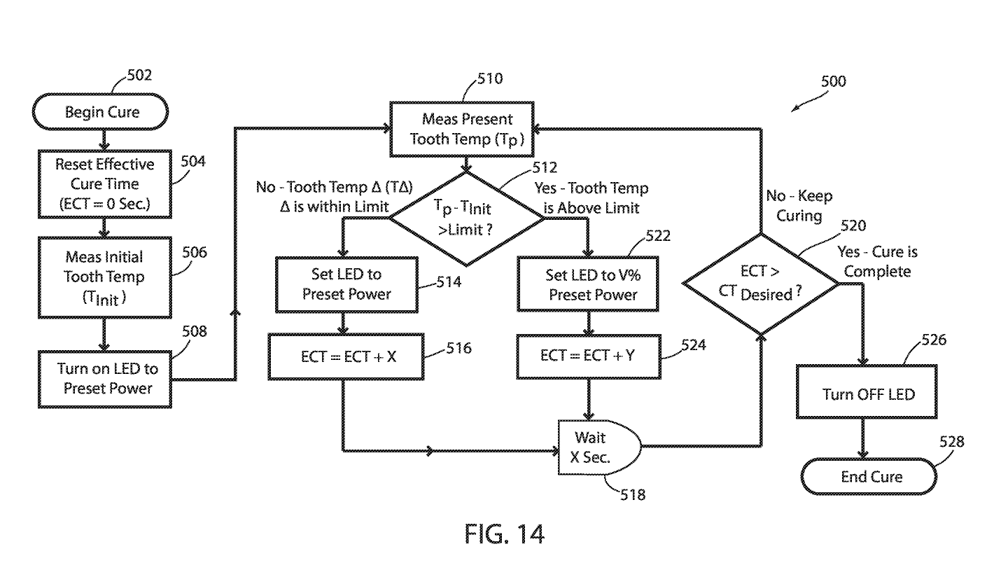

FIG. 14 is a flowchart of third embodiment of a closed loop feedback control that may be used with the curing light device.

### DETAILED DESCRIPTION

Referring to FIG. 1, the numeral 10 generally depicts a curing light device assembly with a base 12 and a curing light device or instrument 14, which can provide light to a composite material during a cure. As will be more fully described below, curing light device 14 may be used to cure a light activated composite material, such as by polymerizing monomers into durable polymers, and further may include a closed loop feedback control of its light output. Further, as will be more fully described below, assembly 10 is configured to calibrate the light of curing light device 14 when the curing light device is located in its stored position within base 12.

Curing light device 14 may be a standalone device, such as a portable handheld wand having a battery power source and controls, or a component of a curing system having a base unit to which the curing light device 14 is tethered and receives power therefrom and optionally control signals therefrom. A variety of fields may benefit from the curing light device 14, including, for example, the dental and medical fields. For purposes of disclosure, curing light device 14 is described as being a dental curing instrument for use in connection with curing a composite material having photo initiator, which absorbs light of a particular wavelength and causes polymerization of the monomers included in the composite material into polymers. It should be understood, however, that the present disclosure is not limited to the curing instrument being a dental curing instrument or limited to use with dental composite material—any curing application may benefit from the curing instrument, and any type of photo curable material may be used in conjunction with the curing instrument, including transparent, translucent and semi-opaque curable materials.

Referring again to FIG. 2, curing light device 14 includes a housing 20, which forms a light application member, and, optionally, an operator interface 22. As noted above, instrument 14 may be a standalone unit or be coupled to a control unit or the like, which may include the operator interface and/or operator feedback element. In use, an operator may activate the curing light device 14 via the operator interface 22 (e.g. a start button “S” (FIG. 1) to initiate a curing operation of a composite material represented generally at TS, the target surface (FIG. 2). After activation, the curing light device 14 may generate and emit light through a light passage of housing 20. The operator may position the housing 20 such that the light passage directs light toward the composite material in order to effect a cure thereof.

In the illustrated embodiment of FIG. 2, curing light device 14 includes a light source 24, a controller 26 (e.g., an embedded controller, such as an embedded microprocessor-based controller), which is coupled to a power supply, such as a battery B), drive circuitry 28, and a UV light sensor 30. Optionally, base 12 includes a recharging circuit, for example, an inductive based recharging circuit, which recharges battery B (located housing 20) when curing light device 14 is located or positioned in its storage position (i.e. its charging position) on base 12. The light source 24 in the illustrated embodiment is primarily an Ultra-Violet (UV) light source, such as a UV light emitting diode (LED), but may be configured differently, including being configured to primarily output infrared light. It should further be understood that the light source 24 of the illustrated embodiment—although primarily one type of light source (e.g., UV)—also may emit light of wavelengths different from those of the primary light type. For instance, the primary light output from a UV LED is UV light, but the UV LED may also emit light in the visible spectrum or infrared spectrum, or both, along with the UV light.

Sensor 30 is in communication with controller 26 via feedback circuitry 30a and configured to detect the light emitted from curing light device 14 when curing light device 14 is located or positioned in its storage position on base 12. Based on the signals from or sensed state of sensor 30 as detected by feedback circuitry 30a, controller 26 is configured, for example via suitable software or firmware, to calibrate light source 24. Consequently, sensor 30 and controller 26 can provide a close loop feedback calibration, which is described more fully below in reference to FIG. 8.

Calibration of light source 24 may be done automatically when curing light device 14 is located or positioned in its storage position on base 12 or it may be triggered by a signal. For example, once controller 26 detects that the battery is being recharged, controller 26 may be configured to initiate the calibration process.

The controller 26 of the curing light device 14 one embodiment may include an algorithmic computational solution element or controller module, such as a shared computational module incorporated into the controller 26, forming an embedded control system that controls light output and potentially additional instrument functionality. Optionally, this module may be separate from the controller 26 and incorporated into another hardware module that along with the controller 26 forms at least part of a control system for curing light device 14.

Control over generation of light from the light source 24, as mentioned herein, may be conducted through the drive circuitry 28 (which is also referred to as an LED power control element but is not so limited). In the illustrated embodiment, the controller 26 may be coupled to and control operation of drive circuitry 28. The controlled level of the operating characteristic or operating characteristics of the drive circuitry 28 may be governed at least in part by the controller 26 to affect the power signal provide to the light source and to affect light output thereof. For example, the controller 26 may provide a control signal or control information to the drive circuitry 28 to provide power to the light source 24 according to a target operating characteristic.

Referring to FIG. 7, a calibration process 100 includes controller 26 powering the light source 24 to a predetermined or selected power value (104). As noted above that step may be preceded by detecting a signal or detecting when the battery is being recharged by the recharging circuit in the base (102), which typically only occurs when the curing light device is located in its stored or charging position in base 12. Using the sensor readings (e.g. signals from or sensed state) of the sensor 30, controller 26 calculates the actual power of the light emitted by light source (106) and then compares the actual power to the predetermined or selected power value (108) to determine the deviation (110). Based on the deviation of the actual power of the light from the predetermined or selected power value of the light, controller 28 adjusts the power output (by adjusting the LED drive current) to the light source (112). This process can be repeated for multiple power values. For example, the calibration process may include a sequential sensing and calibration at multiple levels (at least two) of LED drive current. This enables the firmware to test for proper linearity over multiple levels of drive current. It also allows accurate detection of irradiance at the higher drive levels used during actual cure as well as very low levels, which may be used for “Auto-Start” and “Trigger Safety” types of measurements.

Optionally, once the calibration process is complete, controller 26 terminates power to the light source and, further, may generate a signal, e.g. audible or visual, for example at user interface 22, that the process is complete.

As noted above, the calibration process may be controlled by software or firmware stored in the memory of the controller or may be controlled by circuitry.

Also as noted above, the calibration process may be initiated by a signal. For example, interface 22 may include a touchscreen area or button (e.g. switch) that a user can actuate to manually initiate the control calibration process. Alternately, base 12 may incorporate a position sensor or switch 12a (FIG. 3), which is actuated when the curing light device is located in its stored position (e.g. charging position when base 12 is configured to recharge the curing light device battery).

In the illustrated embodiment, sensor 30 is supported by housing 20 and detects the reflections of the UV light emitted by light source 24. Further, the reflections of the light emitted by light source 24 may be reflections off the surface on which base 12 is supported or by reflective surface formed or provided on base 12.

Referring to FIGS. 1-4, in the illustrated embodiment, base 12 may include a reflective element or surface 12b. For example, a suitable reflective element 12b may be formed from a ceramic that reflects the light back to the sensor. Further, a suitable element may comprise a circular ceramic disc that is mounted to or formed with base 12. For example, when base 12 is formed from injection molding, the reflective element 12b may be injection molded with base 12.

Referring again to FIGS. 1, 2, and 4, reflective element 12b is located so that when curing light device 14 is located in its storage position (e.g. charging position), such as shown in FIG. 1, reflective element 12b aligns with the light opening and light source 24 of curing light device 14. In this manner, the relative position, i.e., distance and angular orientation, of the light source 24 to the reflective element 12b is known—that is the distance and the angular orientation are fixed known values, which means that the calibration process is more accurate and repeatable.

In the illustrated embodiment, base 12 is configured to hold the curing light device in a horizontal position. As would be understood, therefore, the curing light device may be calibrated while positioned horizontally on base 12. With this arrangement, the light source and sensor system of the curing light device may be disposed at a fixed position relative to a horizontal surface. This fixed position relationship with the horizontal surface may facilitate calibration under repeatable conditions. As noted, calibration may be conducted in response to user input or while the curing light is stored on base 12.

Further, by providing the reflective surface at the base 12, the reflective element provides a known reflectance for the light emitted (e.g. blue wavelength of light source 24 described below). A suitable reflective element may include a circular ceramic disc, such as a thin steel disc with a white ceramic coating of known reflectance. This allows the curing light device 14 to “calibrate and correlate” its sensed feedback signal (reflection of light emitted from light source) to a known irradiance value (known reflectance of reflective element) by 1) knowing the reflectance of the disc and 2) knowing the optical power delivered (from a factory calibration of optical power vs. measured LED current). Thus, curing light device 14 is configured to provide closed loop calibration of its light source.

Alternately, as noted above, the reflective surface may be formed by the surface on which the base is supported. In this manner, base 12 is configured to hold the light opening and light source 24 of curing light device 14 in a cantilevered fashion so that the tip of the curing light device 14 is supported above and over the surface on which the base is supported.

Alternately, sensor 30 and controller 26 may be located in base 12 (in lieu of using reflective element 12b) but in communication with light source 24 via a tether as noted above. Further, sensor 30 may be located in base 12 and in communication with another controller—e.g. a base controller (not shown) to provide an open loop calibration process. Similarly, by locating the sensor in base 12 in lieu of using reflective element 12b, sensor 30 will measure the light directly from light source 24 when the curing light device is in its storage position (e.g. charging position) rather than measuring reflected light and will provide the same fixed relative positioning, i.e., distance and angular orientation, between light source 24 and sensor 30, which means that the calibration process is more accurate and repeatable.

As will be more fully described below, this sensor (30) may also allow closed loop control of the light source when used to cure a target. In addition to turning on/off the LED light source and calibrating the light source, controller 26 may also manage the power output during use. For example, controller 26 may control a duty cycle of power applied to the LED light source 24 to control the amount of output power. As another example, controller 26 may control the amplitude or rail voltage of power applied to the LED light source 24 to affect and control output power. In some circumstances, controller 26 may achieve “ramping” exposure profiles.

Accordingly, in one embodiment with all or only some of the features described above, controller 26 may also achieve closed-loop control of light output to a target. Alternatively or additionally as another mode of operation, the curing light device may achieve open loop control of light output to the target. With the ability to sense optical output as feedback, controller 28 may use the feedback to compute, track, and compensate for actual optical energy being delivered to the surface of the tooth. Thus, the controlled dental curing light device may significantly enhance clinical performance and provide enhanced safety in curing dental restorative compounds. In so doing, the controlled dental curing instrument may help to eliminate a great number of variables impacting exposure level at the targeted surface and the subsequent post-procedural problems that sometimes occur with either under exposure (e.g., insufficient cure of compound) or over exposure, which may potentially cause damage to live tissue from over-heating.

For example, the sensing electronics used in the calibration process may also be configured to determine the actual irradiance on the tooth over a variety of exposure distances (typically 0 to 10 mm) and also adjust the LED current (power to the light source) to achieve a consistent desired “on tooth irradiance” over varying exposure distances. Therefore, in addition to determining whether or not optical contamination or gross aging of the LED light source has occurred (which could compromise the accuracy of the curing light device dosimetry), the curing light device can also provide closed loop feedback control the output of the curing light device when in use.

As noted above, drive circuitry 28 controls the supply of power to the light source 24 to generate light that is transmitted via the light opening formed in housing 20 to the reflective surface. When curing light device 14 is removed from base 12 and operated, drive circuitry 28 (which includes control drive circuitry that receives power from an board power source (e.g., battery B) or a hard wired power supply line) provides power as a power signal to the light source 24 according to one or more operating characteristics, such as a voltage magnitude, current magnitude, or duty cycle or a combination thereof. In response to receipt of power, the light source 24 generates light that can be directed to the target or targeted surface for the curing operation.

As noted above, the light source 24, in the illustrated embodiment, is primarily a deep blue and/or an Ultra-Violet (UV) light source, such as a UV light emitting diode (an LED that produces the shorter wave lengths of blue light), but may be configured differently. It should further be understood that the light source 24 in the illustrated embodiment—although primarily one type of light source (e.g., UV)—also may emit light of wavelengths different from those of the primary light type. For instance, the primary light output from a UV LED is UV light, but the UV LED may also emit light in the visible spectrum or infrared spectrum, or both, along with the UV light.

In addition to the calibration firmware or software, controller 26 of the curing light device 14 in one embodiment may include an algorithmic computational solution element or controller module, such as a shared computational module incorporated into the controller 26, forming an embedded control system that controls light output and potentially additional instrument functionality. Optionally, this module may be separate from the controller 26 and incorporated into another hardware module that along with the controller 26 forms at least part of a control system for the curing light device 14.

Control over generation of light from the light source 24, as mentioned above, is conducted through the drive circuitry 28. In the illustrated embodiment, controller 26 is coupled to and controls operation of the drive circuitry 28. The controlled level of the operating characteristic or operating characteristics of the drive circuitry 28 is governed at least in part by the controller 26 to control the power signal provided to the light source and to control the light output thereof. For example, the controller 26 may provide a control signal or control information to the drive circuitry 28 to provide power to the light source 24 according to a target operating characteristic. As will be more fully described below, the control signal or control information provided from the controller 26 may be dynamic such that, during a curing operation, the control signal or control information may vary to effect a change in the target operating characteristic.

The drive circuitry 28, in one embodiment, may utilize feedback circuitry to achieve the target operating characteristic. For instance, the drive circuitry 28 may include a current sensor that senses current supplied to the light source 24, and based on the sensed current, the drive circuitry 28 may adjust operation to vary the supply current to more closely align with a target supply current. Additionally or alternatively, the controller 26 may direct operation of the drive circuitry 28 based on sensed information related to operation of the drive circuitry 28 in supplying power to the light source 24, including, for example, adjusting one or more target operating characteristics, such as duty cycle, based on a deviation between a target current and a sensed operating current.

The drive circuitry 28 may include circuitry that manages the power output during use. The drive circuitry 28 may receive input from the controller 26 to control the output of the light source 24. The drive circuitry 28 may include the capability of managing output power of the light source 24 with more resolution that merely turning ON or OFF or selecting one of two or three preset power levels. For instance, the drive circuitry 28 may control one or more operating characteristics, including, for example, controlling duty cycle of power applied to the light source 24 to control the amount of output power. As another example, the drive circuitry 28 may control the amplitude or the rail voltage, or both, of power applied to the light source 24 to affect and control output power. In some circumstances, the drive circuitry 28 may be controlled by the controller 26 to achieve “ramping” exposure profiles, or exposure profiles or operating profiles that change over the course of the curing operation rather than a profile configured to supply a substantially constant amount of light energy to a target surface. For instance, the curing light device 14 may vary an output level of the light source 24 to effect, e.g. limit, the temperature of the target surface—with the output level of the light source 24 shifted or varied over the course of the curing operation while the controller 26 controls supply of power to the light source 24 according to the temperature of the target surface, as more fully described below.

In the illustrated embodiment, controller 26 of the curing light device 14 controls the drive circuitry 28 based on feedback obtained from sensor 30. Such feedback-based control may be implemented in conjunction with any of the control methodologies described herein, including, for example, controlling one or more operating characteristics, e.g. of the light source, based on feedback from the light source 24. As will be more fully described below, curing light device 14 according to one embodiment may additionally implement closed loop control of light output based on a sensed parameter or characteristic of light reflecting from the target surface, which itself may be indicative of the light energy at or reaching the target.

In one embodiment, controller 26 of curing light device 14 is configured to use the feedback from sensor 30 to measure the reflected light off the target to control operation of light source 24 based on how much energy actually reaches the target surface TS. The curing light device 14 may further be configured to utilize feedback to adjust the light output of light source 24 in order to substantially reduce or eliminate the effects of external error sources, which can often be the principal factor or factors in how much optical energy makes it to the targeted surface.

In other words, curing light device 14 may be configured to control an amount of total optical energy applied (Joules) to the intended target, and in so doing, the rate of power applied to the target (mW/cm²) during the exposure time may be controlled to avoid exceeding a target level of optical energy. Control over optical energy output based on optical feedback can be achieved in a variety ways.

The curing light device 14 according to yet another embodiment may include a light sensor element in the feedback circuitry 30a that receives light or a characteristic thereof via the optical feedback path of the sensor 30 (also referred to as a feedback sensor). The light sensor element of the curing light device 14 may be located so as to be systematically connected to the controller 26 so that output of light from the light source 24 may be controlled based on sensed light. The light sensor element of the feedback circuitry 30a may be a photodiode that is sensitized to one or more wavelengths of light, such as the spectrum of light corresponding to UV radiation. It should be understood that any type of light sensor element may be incorporated into the feedback circuit 30a, and that the light sensor element may be sensitive to more than one spectrum of light. The optical sensor feedback signal received by the controller 26 may be an analog signal from the feedback circuitry 30a. The controller 26 may be configured to convert the analog signal to digital information for further processing as described herein. Additionally, or alternatively, the optical sensor feedback signal provided by the feedback circuitry 30a may be a digital signal representative of information or data relating to reflected light sensed by the light sensor element of the feedback circuitry 30a.

As an alternative or in addition to the light sensor element, the curing light device 14 may utilize a light and/or heat sensor that is located at or substantially near the targeted surface of the tooth. This configuration may offer enhanced accuracy for controlled delivery of energy to the tooth. This configuration may also be usable with or without calibration.

In one embodiment of the curing light device 14, the feedback sensor 30 may serve to preferentially collect some portion of the light reflected off from the surface of the intended target area of the area (e.g., the composite material) being treated, and may also serve to deliver this light to the light sensor element of the feedback circuitry 30a for quantification. The feedback sensor 30 may be positioned relative to the housing 20 such that a light input of the feedback sensor 30 is disposed to collect light reflected from the target surface. In the illustrated embodiment shown in FIG. 6, the feedback sensor 30 may be an optical fiber with the light input being formed at a distal end of the optical fiber. The light input may be surface treated, such as by polishing, so that the light input is configured to collect reflected light, as described herein.

In one embodiment, the optical fiber may be configured such that a distal end corresponding to the light input is constructed as a side-firing tip. With this construction, the optical fiber may collect light at an angle different from a central axis of the optical fiber, including, for example, light directed substantially perpendicular with respect to a central axis of the optical fiber. The distal end of the optical fiber in a SIDE-FIRE configuration may be treated such that a surface of the distal end is angled (e.g., about 42 degrees) relative to the central axis of the optical fiber. It should be understood that the feedback circuitry 30a may be arranged to collect light at different angles, including, for example, between 20 and 160 degrees relative to the central axis of the optical fiber.

In the illustrated embodiment, the light sensor 30 may not be configured for the purpose of sensing LED output from the light source 24, but rather to sense the light reflected back from the targeted surface. This light sensor arrangement may achieve an optical connection between the feedback circuitry 30a and the “target” surface via the optical path element or light sensor 30. Such an optical path may be accomplished by an isolated, dedicated optical fiber, or by other blended optical arrangements, so as to enable the optical signal received by the light sensor of the optical feedback circuitry to largely, or at least in part, include the light reflected off of the targeted surface. The sensor feedback signal, generated by the feedback circuitry 30a and based on the light provided via the optical path of the light sensor 30, may then be processed by the controller 26 to eliminate or greatly reduce known and derived sensory error sources as well as to compensate for optical factors impacting the optical sensor feedback signal and to thereby compute in real-time a “delivered” energy level (in mW/cm²) at the actual targeted surface. As explained herein, the computation of actual irradiance level at the targeted surface may form a basis of operation according to one or more methods or modes of operation.

In one embodiment, the controller 26 may be configured to control the output of light from the light source 24 based on the optical sensor feedback signal according to a first operational mode in which the real-time “delivered” energy value may be digitally integrated during the time of the exposure to compute the total Joules of energy delivered to the targeted surface up to that point. As the delivered energy reaches the desired level (for example, 48 Joules for a dark shade restoration) the controller 26 of the curing light device 14 may automatically turn off the light source 24 and notify the operator that the exposure has been completed.

In another operational mode, the curing light device 14 may use the computed irradiance at the targeted surface (e.g., the tooth or composite material surface) to create an “error value” in real time that represents the over or under exposure at the targeted surface for that moment in time with respect to a target irradiance level initially set or expected by the operator of the curing light device 14. This error signal may be used as a basis for throttling the light source 24 up or down to substantially ensure that the target surface is receiving a desired amount of mW/cm² of irradiance at any given moment of the curing process or operation. This second mode may also help to ensure that overly intense irradiation levels are avoided instead of merely shortening the total exposure time.

A partially exposed and partial sectional view of the housing 20 according to one embodiment of the curing light device 14 is depicted in the illustrated embodiment of FIG. 6. As noted above, housing 20 may include the drive circuitry 28, the light source 24, the feedback circuitry 30a, and the feedback sensor 30. The housing 20 may also include a hemispherical lens 50 mounted to the light source 24, a plano-convex lens 52 configured to direct light energy from the light source 24 to a target surface and a reflector ring 56 configured to direct light toward the plano-convex lens 52. The housing 20 may also include a bezel or outer retainer ring 54 constructed to maintain the position of the plano-convex lens 52, the light source 24, and the reflector ring 56. It should be understood that one or more of the lens types and lens construction of the housing 20, as well as the physical arrangement or use of one or more components including the bezel 54 and the reflector ring 56, may be different and may vary from application to application.

In the illustrated embodiment, the light source 24 and the light input of the feedback sensor 30 may be disposed such that an optical path 62 of the light input is within an optical path 64 of the light source 24. For instance, the optical path 62 of the light input may be coaxial and narrower with respect to the optical path 64 of the light source 24. In operation, the optical path 62 of the light input may be arranged to collect light to sense as a basis for controlling operation of the curing light device 14, whereas the optical path 64 of the light source 24 may be arranged to direct light from the light source 24 to a target surface. The optical path 62 may be considered part of the optical feedback path provided by the feedback sensor 30 to channel light to the light sensor of the feedback circuitry 30a.

At manufacture, as discussed herein, the feedback sensor 30 may be energized from a light source to emit light from the light input, thereby facilitating alignment of the optical path 62 of the light input with respect to the optical path 64 of the light source 24. For instance, by emitting one type of light from the light input, a comparison can be made against another type of light emitted from the light source 24 in order to align the optical path 62 of the light input with respect to the optical path 64 of the light source 24. After alignment has been conducted, the feedback sensor 30 may be secured in place, such as by utilizing optical glue to affix a portion of the feedback sensor 30 to a portion of the housing 20, to substantially prevent linear and rotational movement of the light input of the feedback sensor 30.

By aligning the optical path 62 of the light input with respect to the optical path 64 of the light source 24, the curing light device 14 may achieve enhanced accuracy in the optical sensor feedback signal used by the controller 26 to provide the closed loop control of the curing light device 14.

In the illustrated embodiment of FIG. 6, the light input of the feedback sensor 30 may be disposed to capture the light reflected from the target surface, and such that the optical path 62 is aligned with and coaxial about a central axis 60 of the optical path 64 of the illuminating beam of the light source 24. In this way, the optical path 62 of the light input may be considered a sensing optical path, and the optical path 64 of the light source 24 may be considered an illuminating optical path. Alignment of the illuminating and sensing optical path, such as coaxial alignment of these optical paths, may assure that the sensed zone of the target surface does not substantially migrate within the illuminated zone of the target surface as a function of distance from the source. In other words, if the pair of illuminated and sensed optical paths (or “beams”) 64, 62 have different trajectories, the sensed zone of the sensing optical path 62 may move substantially outside the illuminated zone of the target surface as the distance between the housing 20 and the target surface increases. By aligning the sensing beam or “viewed area” of the target surface with the illumination beam, the illumination beam can be convergent, divergent, or even highly collimated, or a combination thereof, without significantly affecting the feedback signal generated from the sensing beam.

Alignment of the illumination optical path 64 and the sensing optical path 62, including coaxial alignment, with respect to the target surface may help to assure that the optical sensor feedback signal is stable over varying distances. Distance is one of the principal variables introduced into a curing operation during handheld operator use. Stabilization of the optical sensor feedback signal over varying distances may enable the curing light device 14 to compensate for operator introduced variations in distance, enabling more accurate delivery of light during a curing operation.

Alignment of the optical path 62 of the light input and the optical path 64 of the light source 24 may be achieved in a variety of ways, as discussed herein. In one embodiment, this alignment may be achieved by utilizing a beam splitter technique, including, for example, directing light from the light source through a 45 degree beam splitter so that part of this light is directed to a first side and the other part of this light is directed to the target surface. Light reflected from the target surface may interface with the beam splitter such that some of the reflected light passes through toward the light source, and the other part of the reflected light is directed to a second side, which is opposite the first side. A sensor may be optically coupled to the second side to detect a characteristic of the reflected light, which can be used as a basis for closed loop feedback control of the light source.

In the illustrated embodiment, the optical path 62 of the light input may be aligned with the optical path of the light source 24 through management of the physical size of the light input and the feedback sensor 30, enabling collection of light via the optical path 62 where the light input is substantially small relative to an intersecting surface area of the optical path 64 or the illumination beam. In other words, the feedback sensor 30, including the light input, may be constructed and positioned such that the amount of area of the optical path 64 that is covered by the feedback sensor 30 is small in relation to the total area of the optical path 64 in the same plane as the covered area. In this way, a shadowing effect of the feedback sensor 30 may be reduced, or put differently, the feedback sensor 30 may be constructed and positioned so that it does not provide a measurable or significant impact on the uniformity or intensity of the illumination beam on the target surface. As an example, the feedback sensor 30, as described herein, may be a “SIDE-FIRE” type of optical fiber in which the light input corresponds to a distal end that is terminated and polished to achieve a near right angle distribution cone or reception cone, or both, at the light input. A small optical fiber may be utilized, e.g., within range of 0.005″ to 0.020″ in diameter, such as 0.010″ in diameter, with a side-fire optical termination (as provided, for example, by Polymicro Fibers), and placed into the illumination path close to the light source 24 with a coaxial alignment to avoid significant shadowing. This construction may achieve a useful alignment of the optical path 62 and optical path 64 in a cost-effective manner without substantially adversely affecting curing of the target surface with the light source 24.

The curing light device 14 according to one embodiment may be a high power (>2000 mW/cm²) LED based dental curing wand. More specifically, the curing light device 14 may be capable of varying an optical output level of the light source 24, such as a high power LED, to cure a dental composite material according to manufacturer specifications for the material. The curing light device 14 may form part of an optical delivery system that according to one embodiment may be capable of sustaining at least 2000 mW/cm² at a target distance of 2 cm to 5 cm from the a tip of the housing 20, and may be configured such that a profile of irradiance across the beam generated by the tip is substantially homogeneous within 20% of the average power across the tip. It should be understood that the present disclosure is not limited to these features and that alternative instrument or wand configurations are contemplated.

A curing light device 14 according to one embodiment with all or some of the features described above may achieve closed-loop control of light output to a target surface. Alternatively or additionally as another mode of operation, the curing light device 14 may achieve open loop control of light output to the target surface. With the ability to sense optical output as feedback, and to use the feedback to compute, track, and compensate for actual optical energy being delivered to the surface of the tooth, the curing light device 14 may significantly enhance clinical performance and provide enhanced safety in curing dental restorative compounds. In so doing, the curing light device 14 may help to substantially eliminate a great number of variables impacting exposure level at the targeted surface and the subsequent post-procedural problems that sometimes occur with either under exposure (e.g., insufficient cure of compound) or over exposure, which may potentially cause damage to live tissue from over-heating.

A curing light device 14 according to one embodiment may be configured with a quality optical design by implementing controlled manufacturing processes to produce an instrument that demonstrates a substantially homogeneous field of light across the tip of the instrument that is consistent from use to use, even if the light source 24, itself, is inclined to exhibit a slight, but continuous, decay in its output level over its “life”. It is noted that LEDs often times do not “burn out” in a catastrophic fashion as do their incandescent counterparts, but rather tend to slowly decrease in intensity over their life. LED lifetime can be expressed as the number of hours before they reach either 50% or 70% of original intensity, depending on the LED “life” standard that is being used. As described above, controller 26 of the curing light device 14 may adjust output intensity of the light source 24 based on the sensor feedback signal to counteract degradation of the light source 24 over its lifetime using the calibration process described above.

The controller 26 may also conduct diagnostic analysis based on the sensor feedback signal, such as determining whether the light source 24 is operating according to one or more operational parameters sufficient for conducting a cure operation. In this way, the controller 26 of the curing light device 14 may conduct built in diagnostics (BID). Additionally, or alternatively, the BID conducted by the controller 26 may include analysis of battery or power source stability or sufficiency or both, and determining whether contamination is present on a lens or tip through which light is emitted from the housing 20.

After light from the light source 24 reaches the tip of the instrument, many additional variables can, and sometimes do, impact the effective delivery of those photons onto the intended surface. In cases of hand held use by an operator, probably the most significant of these variables is the operator's accuracy (or variance) with respect to placement of the curing light device 14 during the time of the exposure or the curing operation. Depending on various factors, such as the optical design of the tip of the housing 20, its effective numerical aperture, and the geometry of tip diameter vs. intended working distance, a variation of better than 5 to 1 can be experienced in light attenuation during hand held curing operations. As an example, clinically relevant irradiance has been demonstrated to drop off significantly in some cases due to a change in target distance from 2 mm to 8 mm. Furthermore, additional variation as high as 2 to 1 may occur from angular variation between the axis of the tip surface and the normal of the target surface being treated. The curing light device 14 according to one embodiment may be configured to substantially account for this variability by utilizing closed loop feedback based on sensed light reflected from the target surface, thereby enabling control over the irradiance.

It should be understood that the curing light device 14 according to one embodiment may implement closed loop control of light output based on a sensed parameter or characteristic of light reflecting from the target surface, which itself may be indicative of the light energy at or reaching the target. In addition to basing control on the light sensed at the target, the instrument may internally sense internal light output from the light source 24 of the curing light device 14. Internally sensing the light output, alone without determining the amount of light externally applied to the target, may allow the curing light device 14 to compensate for aging or variations in the light source or lamp, but generally does not account for variables that may exist between the source generation of the curing light device 14 and the intended final target destination of the light. Operator variations from use to use may be compensated for by sensing a parameter indicative of the light actually reaching the target.

The acceptance and utilization of composites for dental restoration has grown tremendously over the last couple of decades, including use of composites on anterior teeth. Use of anterior tooth composites has given rise to composites of different shades to match the same color of the natural tooth to which the composite is being applied. The different shade offerings, in many cases, call for different amounts of target light energy to complete a cure. Darker shades often cause much more internal attenuation of light as it is scattered about and transmitted through the composite material. This often results in increased target energy to cure the darker shades. As an example, a popular line of restorative compound offered by Dentsply cures at about an energy of 6 Joules/cm² for lighter shades, but cures at 48 Joules/cm² for darker shades. This is an eight-to-one variation in prescribed energy delivery and as such represents an additional 8 fold increase in the total range of appropriate energy levels that may now be prescribed to achieve a target cure for various composite materials.

The curing light device 14 according to one embodiment may be configured to cure a restorative compound by controlling light output during the cure cycle to achieve a target output, possibly specific to the curable material or restorative compound being used. For instance, the operator may utilize the operator interface 22 to select a target cure setting for a curing operation that is prescribed by a manufacturer of the curable material being used. In this way, the amount of light energy applied during a curing operation may be selectively chosen based the material being used rather than “over-curing” the curable material by a factor of two or three to eliminate a potential under-cure due to distance, angle, or other external variation factors. If curing intensity levels are considered low (e.g., 200 to 300 mW/cm²), intentional over-curing a curable material by a factor of two or three to eliminate a potential under-cure due to distance, angle, or other external variation factors is often not considered to be an issue. However, with use of curable materials that prescribe higher cure energies, and therefore a higher energy curing instrument (e.g., an instrument that produces at least 1200 mW/cm² and possibly up to 3000 mW/cm² or more), intentional over-curing can result in application of energy that is an order of magnitude greater than that of direct sunlight (e.g., 100 mW/cm²). The curing instrument in the illustrated embodiment of FIGS. 5 and 6, may utilize optical feedback based on light reflected from the target surface to control the delivery of light energy, thereby substantially avoiding significant over-curing and intentional over-curing procedures that generate light energies two to three times the prescribed amount.

A method of operation of the curing instrument or curing system according to one embodiment is depicted in the illustrated embodiment of FIG. 9, and generally designated 200. The method 200 may be implemented as a control module in the controller 26 using feedback based on one or more parameters or characteristics, such as reflected light from the target surface, and one or more sense characteristics of the curing light device 14, itself. In the illustrated embodiment, the method 200 may include initiating a cure operation and resetting an accumulator or integrator that tracks an amount of light energy delivered to a target surface. Steps 210 and 212. The controller 26 may then instruct the drive circuitry 28 to power the light source 24 according to an initial setting, such as a preselected source power level, thereby starting application of light to the targeted surface. Step 214. The real-time “delivered” energy value may be digitally integrated during the time of the exposure to computationally represent the total Joules of energy delivered to the targeted surface up to a given point in time. Steps 216, 218. As the delivered energy reaches the desired level (for example, 48 Joules for a dark shade) the controller 26 may automatically turn off the light source 24 and notify the user that the exposure has been completed. Steps 220, 222, 224. In this way, the curing light device 14 may vary the exposure time to compensate for factors affecting delivery of light energy to the target surface, such as distance or angular variations present during each use.

Another method of operating the curing instrument according to one embodiment is depicted in the illustrated embodiment of FIG. 10, and generally designated 300. The method 300 may be implemented by a controller 26 similar to the method 200. In the illustrated embodiment, the method 300 may include initiating a cure operation and initializing or resetting an accumulator or integrator that tracks an amount of light energy delivered to a target surface. Steps 310 and 312. Initiation of a curing operation may start in response to activation of a user input (e.g., a button) of the operator input 22. The controller 26 may then instruct the optical drive circuitry 28 to power the light source 24 according to an initial setting, such as a preselected source power level, thereby starting application of light to the targeted surface. Step 314. The method 300 may further include computing irradiance at the targeted surface to generate an error value in real-time that represents the over or under exposure at the targeted surface for that moment in time with respect to a target irradiance level initially set or expected by the operator. Steps 318, 320.

This error signal may then be used as a basis for adjusting the drive circuitry 28 so as to either increase or reduce output from the light source 24 by a calculated value and thereby assure that energy losses between the light source 24 and the target surface are compensated and that the target surface is receiving the target number of mW/cm² of irradiance at any given moment of the curing process. Steps 322, 324, 326. As an example, at step 322, the method 300 may determine whether the amount of irradiance delivered (I_{delivered}) is greater or less than a calculated amount of expected irradiance, which may correspond to the desired or expected amount of irradiance (I_{desired}) for a given time. As another example, the method 300 may determine whether the amount of energy delivered (J_{delivered}) is greater or less than a calculated amount of expected energy, which may correspond to the desired or expected amount of energy (J_{desired}) for a given time period, or correspond to a fraction of the total prescribed amount of energy for the curing operation for the period of time since the curing operation was initiated. The method 300 may facilitate substantial avoidance of overly intense irradiation levels instead of shortening the total exposure time.

The method 300 of the illustrated embodiment may after a predetermined amount of time, such as 0.01 s, determine, based on the optical sensor feedback signal, whether the total amount of energy delivered to the target surface meets or exceeds a threshold corresponding to a prescribed amount of light energy for a curing operation. Steps 328, 330, 332. If the calculated amount of total energy satisfies this condition, the curing operation may be terminated. Steps 332, 334. If the condition is not met, the curing operation may continue such that the calculated amount of energy is determined iteratively until the calculated amount of total energy satisfies the condition. Steps 332, 316.

The curing light device 14 according to one embodiment may provide a construction that substantially ensures curable materials, such as composite dental materials, receive sufficient energy to properly cure the curable material without relying on a conventional and much less accurate approach of simply doubling or tripling a calculated exposure time. In this way, a substantially effective energy deliverance to the target surface may be achieved. It should be understood that the techniques and embodiments described herein may be extended to non-dental applications such as industrial manufacturing where precise light cure of adhesives or similar composite fills are utilized.

Optionally, the curing light device 14 may be configured to least one of prevent operation or alert the operator of issues related to improper alignment or an insufficient capability to deliver energy, such as in case a curing operation appears, based on the optical sensor feedback signal, to be insufficient to properly cure the curable material. As an example, if the curing light device 14 is improperly angled, possibly due in part to an improperly trained operator, the controller 26 may detect that the curing operation is insufficient to cure the target material, and alert the operator accordingly, or discontinue operation, or both.

A method of the curing instrument or curing system according to one embodiment is depicted in the illustrated embodiment of FIG. 11, and generally designated 400. In the illustrated embodiment, the method 400 may be conducted prior to conducting a curing operation according to one or more of the methods described herein, such as the methods 200, 300. The method 400 may include, in response to activation of a user input of the operator input 22 (e.g., a button), resetting or initializing an accumulator or integrator of sensed energy delivered to a target surface. Steps 410 and 412. The controller 26 may then instruct the drive circuitry 28 to power the light source 24 according to an initial setting, such as a preselected source power level, thereby starting application of light. Step 414. The controller 26 may analyze the optical sensor feedback signal provided from the optical feedback circuitry 26 to determine if the sensed reflected light is indicative of the curable material actually being targeted by the housing 20. Steps 416, 418. As an example, the controller 26 may compare the sensed light to a threshold, parameter, or parameter range associated with the type of curable material being targeted to determine whether the curable material is actually receiving light from the light source 24. If the sensed light is less than the threshold, or deviates from the parameter range, the controller 26 may determine the curable material is improperly positioned relative to the housing 20 such that a curing operation is unlikely to be effective. Based on this determination, the controller 26 may discontinue operation of the light source 24 or alert the operator of an issue via the operator feedback circuitry 14, or a combination thereof. Step 420, 422. If the sensed light satisfies one or more criteria, such as being greater than a threshold, indicative of proper targeting of the curable material, the controller 26 may proceed with further steps in the curing operation, including one or more steps described herein in connection with the methods 200, 300. The method 400 may transpire over the course of several microseconds to substantially avoid application of light energy to surfaces other than that of a known or desired type of target.

In an addition to or as an alternative to one or more embodiments described herein, the curing light device 14 may include an air path to conduct air or another gas toward or away from the target surface, thereby cooling the target surface or the surrounding area, or both, gas flow, such as directing water vapor or water mist toward the target surface.

In one embodiment, a method of manufacture of the curing light device 14 may include assembling the housing 20 by aligning the optical path 62 of the feedback sensor 30 with the optical path 64 of the light source 24. The method may include energizing the feedback sensor 30 such that light is emitted from the light input. The light input may be disposed a) in proximity to a lens 50 that is mounted to the light source 24 and b) within a void or area defined between the lens 50 and another lens 52. The light source 24 may be energized to emit light at the same time as light is emitted from the light input. The feedback sensor 30 may be rotated and moved such that the side-fire termination corresponding to the light input directs light along the optical path 62 within the optical path 64 of the light source 24. Once alignment between the optical path 62 in the optical path 64 has been achieved, the feedback sensor 30 may be affixed in place such that the light input remains substantially stable with respect to the lens 50. In one embodiment, a calibration sensor system may detect the relative positions of the optical path 62 of the light input and the optical path 64 of the light source 24 to facilitate alignment thereof. The light emitted from the light input during a calibration or alignment may be of a type different from that emitted from the light source 24 to facilitate differentiating between the optical path 62 and the optical path 64.

In one embodiment, to control the output of light according to a first mode, the real-time “delivered” energy value may be digitally integrated during the time of the exposure to compute the total Joules of energy delivered to the targeted surface up to that point. As the delivered energy reaches the desired level (for example, 48 Joules for a dark shade restoration) the LED power control element of a controlled dental curing instrument according to one embodiment may automatically turn off the LED and notify the user that the exposure has been completed. In a second operational mode option, the curing instrument may use the computed irradiance at the tooth to create an “error value” in real time that represents the over or under exposure at the tooth for that moment in time with respect to the target irradiance level initially set or expected by the user of the curing instrument. This error signal may be used as a basis for throttling the LED power up or down so as to assure that the instrument target is substantially receiving the desired number of mW/cm² of irradiance at any given moment of the curing process. This second mode may also help to ensure that overly intense irradiation levels are avoided entirely instead of merely shortening the total exposure time.

A controlled dental curing instrument according to one embodiment includes a light sensor element and an optical path element. Some conventional dental light wands operate with means for testing the optical output, such as in the base of the charging stand. The controlled dental curing instrument of the present invention is different. The light sensor element of the controlled dental curing instrument is located so as to be systematically connected to a controller capable of affecting the output of light from the instrument.

As an alternative or in addition to the light sensor element, the controlled dental curing instrument may utilize a light and/or heat sensor that is located at or substantially near the targeted surface of the tooth. This configuration may offer enhanced accuracy for controlled delivery of energy to the tooth. This configuration may also be usable with less or without calibration.

In one embodiment of the controlled dental curing element, the optical path element may serve to preferentially collect some portion of the light reflected off of the surface of the intended target area of the tooth being treated, and may also serve to deliver this light to the light sensor element for quantification.

As noted above, in one embodiment, curing light device 14 may also incorporate a temperature, such as a conventional non-contact temperature sensor, which detects infra-red radiation (IR) and is configured to sense the temperature at the target based on the infra-red radiation emitted from the target.

Referring to FIGS. 12-13, the numeral 114 generally depicts another embodiment of a curing light device for providing light to a composite material during a cure. As best seen in FIG. 13, curing light device 114 includes a housing 120, and optionally an operator interface 122 (FIG. 12, similar to interface 22 in FIG. 1) with user actuatable devices (such as touch screen areas or buttons) and an operator feedback element, such as a display (FIG. 12). Similar to the previous embodiment, curing light device 114 may be a standalone unit or be coupled to a control unit or the like, which may include the operator interface and/or operator feedback element. In use, an operator may activate the curing light device 114 via the operator interface 122 (e.g. a start button “S” (FIG. 1) to initiate a curing operation of a composite material represented generally at TS, the target surface (FIG. 8). After activation, the curing light device 114 may generate and emit light through a light passage of the housing 120. The operator may position the housing 120 such that the light passage directs light toward the composite material in order to effect a cure thereof.

In the illustrated embodiment of FIG. 12, curing light device 114 includes a controller 126 (e.g., an embedded controller, such as an embedded microprocessor-based controller), drive circuitry 128, a light source 124, a temperature sensor 130, and temperature sensor feedback circuitry 130a. The drive circuitry 128 controls the supply of power to the light source 124 to generate light that is transmitted via the housing 120 to the target surface. For instance, the drive circuitry 128 may include control drive circuitry that receives power from a power source (e.g., a battery of the curing light device 114 or a hard wired power supply line), and provides that power as a power signal to the light source 124 according to one or more operating characteristics, such as a voltage magnitude, current magnitude, or duty cycle or a combination thereof. In response to receipt of power, the light source 124 generates light that can be directed to the target or targeted surface for the curing operation. The light source 124, in the illustrated embodiment, is primarily a deep blue and/or an Ultra-Violet (UV) light source, such as described above in reference to light source 124.

The controller 126 of the curing light device 114 in one embodiment may include an algorithmic computational solution element or controller module, such as a shared computational module incorporated into the controller 126, forming an embedded control system that controls light output and potentially additional instrument functionality. Optionally, this module may be separate from the controller 126 and incorporated into another hardware module that along with the controller 126 forms at least part of a control system for the curing light device 114.

Control over generation of light from the light source 124, as mentioned above, is conducted through the drive circuitry 128, which is also referred to as an LED power control element but is not so limited. In the illustrated embodiment, the controller 126 may be coupled to and control operation of the drive circuitry 128. The controlled level of the operating characteristic or operating characteristics of the drive circuitry 128 is governed at least in part by the controller 126 to control the power signal provided to the light source and to control the light output thereof. For example, the controller 126 may provide a control signal or control information to the drive circuitry 128 to provide power to the light source 124 according to a target operating characteristic. As will be more fully described below, the control signal or control information provided from the controller 126 may be dynamic such that, during a curing operation, the control signal or control information may vary to effect a change in the target operating characteristic.

The drive circuitry 128, in one embodiment, may utilize feedback circuitry to achieve the target operating characteristic. For instance, the drive circuitry 128 may include a current sensor that senses current supplied to the light source 124, and based on the sensed current, the drive circuitry 128 may adjust operation to vary the supply current to more closely align with a target supply current. Additionally or alternatively, the controller 126 may direct operation of the drive circuitry 128 based on sensed information related to operation of the drive circuitry 128 in supplying power to the light source 124, including, for example, adjusting one or more target operating characteristics, such as duty cycle, based on a deviation between a target current and a sensed operating current. For instance, in the illustrated embodiment, the curing light device 114 may vary an output level of the light source 124 to effect, e.g. limit, the temperature of the target surface—with the output level of the light source 124 shifted or varied over the course of the curing operation while the controller 126 controls supply of power to the light source 124 according to the temperature of the target surface, as more fully described below.

In the illustrated embodiment, controller 126 of the curing light device 114 controls the drive circuitry 128 based on feedback obtained from temperature sensor 132. Such feedback-based control may be implemented in conjunction with any of the control methodologies described herein, including, for example, controlling one or more operating characteristics, e.g. of the light source, based on feedback from the light source 124. Temperature sensor 132 may be a conventional non-contact temperature sensor that detects infra-red radiation (IR) and is configured to sense the temperature at the target based on the infra-red radiation emitted from the target.

In the illustrated embodiment, the IR radiation is directed along a feedback path, such as an optical feedback path, configured to channel the radiation to feedback circuitry 132a. Based on the temperature feedback from the temperature sensor 132, the feedback circuitry 132a will generate a temperature sensor feedback signal indicative of the sensed temperature and provide the temperature feedback signal to the controller 126. By analyzing the temperature feedback signal, controller 126 may dynamically vary the control signal or control instructions provided to the drive circuitry 128, thereby dynamically adjusting one or more operating characteristics of the drive circuitry 128 and, hence, of the output from the light source 124 based on the temperature (e.g. change in temperature as described below) at the target.

Additionally, or alternatively, the controller 126 may determine one or more timing aspects related to delivery of light, and dynamically calculate or adjust a duration for applying light to the targeted surface. For instance, based on the temperature feedback signal, the controller 126 may determine whether the temperature sensed at the target surface exceeds threshold value or a temperature limit or exceeds a change-in temperature limit, and instruct or command the drive circuitry 128 to discontinue delivering or reduce the amount of light energy that is directed toward the target in response to the temperature or change-in temperature reaching or exceeding a threshold value or limit.

In one embodiment of the curing light device 114, temperature sensor 132 is positioned relative to the housing 120 such that the input to the temperature sensor 132 is disposed to collect radiation emitted from the target. The temperature sensor 132 according one embodiment may include an optical fiber with the input being formed at a distal end of the optical fiber similar to the optical fiber used for sensor 30 describe above. The input may be surface treated, such as by polishing, so that the input is configured to collect the radiation, as described herein.

In one embodiment, the optical fiber is configured such that a distal end corresponding to the input is constructed as a side-firing tip. With this construction, the optical fiber may collect radiation at an angle different from a central axis of the optical fiber, including, for example, radiation directed substantially perpendicular with respect to a central axis of the optical fiber. The distal end of the optical fiber in a SIDE FIRE configuration may be treated such that a surface of the distal end is angled (e.g., about 42 deg.) relative to the central axis of the optical fiber. It should be understood that the feedback circuit 132a may be arranged to collect radiation at different angles, including, for example, between 20 and 160 degrees relative to the central axis of the optical fiber.

In the illustrated embodiment, as noted, temperature sensor 132 is configured to sense the radiation emitted from the target. This temperature sensor arrangement may achieve an optical connection between the feedback circuitry 132a and the “target” surface via the temperature sensor 132 and the housing 120, described more fully below. Such an optical path may be accomplished by an isolated, dedicated optical fiber as noted, or by other blended optical arrangements, so as to enable the signal received by the temperature sensor to largely, or at least in part, include the radiation emitted from the targeted surface. As will be more fully described, the feedback may also include information related to light reflected off the target.

The temperature feedback signal, generated by the feedback circuitry 132a, may then be processed by the controller 126 to eliminate or greatly reduce known and derived sensory error sources, as well as to compensate for factors impacting the feedback signal and to thereby compute in real-time the temperature (or change in temperature) at the actual targeted surface. As explained herein, the computation of actual temperature (or change in temperature) at the targeted surface may form a basis of operation according to one or more methods or modes of operation.

In the another embodiment, as shown in FIG. 13, sensor 132 maybe mounted to the housing 120 offset from the optical path of the light emitted from light source 124. The thermal sensor electronics 132a may be housed with the respective sensor 132 or may be located on a separate circuit board located in the housing of housing 120 closer to or at the controller 126, with the sensor 132 in communication with the thermal sensor electronics or controller 132a via wiring (not shown) that extends through the housing of housing 120.

As best seen in FIG. 13, the housing that forms housing 120 includes an extended portion 120a with a cavity 120b that is open to or in communication with cavity 120c, which holds the light source and lenses described below. Extended portion 120a houses and supports temperature sensor 132 and includes an opening 120d that forms a window through which sensor 132 senses the heat at the target, namely the tooth restoration.

The housing 120 supports light source 124 on one end of a support arm that extends through the housing and supports the controller 126 on the opposed end nearer the user inputs (similar to as shown in FIG. 1). Further, housing 120 may also include a lens configured to direct light energy from the light source 124 to the targeted surface and an optional reflector ring 156 configured to direct light from light source 124 toward the lens. Optionally, the housing 120 may include a custom lens such as a Fresnel lens, with elements for focusing the UV light as well as elements to collect longer wave IR light. The housing 120 may also include a bezel or outer retainer ring 154 constructed to maintain the position of the lens, light source 124, and reflector ring 156 at the application end of the housing 120. It should be understood that the construction of the lens of the housing 120, as well as the physical arrangement or use of one or more components including the bezel 154 and the reflector ring 156, may be varied from application to application.

In the illustrated embodiment, the light source 124 and input of the temperature sensor 132 are offset from each other so that the sensor is not coaxial with the light source illumination cone. Temperature sensor 132 is disposed to capture the radiation emitted from the target, and such that its optical path is offset from a central axis 160 of the optical path of the illuminating beam of the light source 124. For additional details of the components and operation of the components of curing light device 114 reference is made to curing device 14.

Referring to FIG. 14, in one embodiment, the controller 126 is configured to control the output of light from the light source 124 based on the temperature feedback signal according to a first operational mode in which the real-time temperature is measured. When the change-in temperature of the target exceeds a maximum change-in temperature limit, the controller 126 of the curing light device 114 lowers the power on the light source and, further, optionally extends the cure time to achieve a complete cure. It should be understood that the controller 126 may instead base its control of the light source on the absolute temperature measured at the target instead of the change in temperature, but additional compensation may have to be made for variations in emissivity of the target and tolerances in the components, for example from aging or inherent variations in the light source.

As described above, curing light device 114 according to one embodiment may additionally implement a closed loop or open loop calibration process using a sensor 130 with sensor feedback circuitry 130a, similar to sensor 30 and sensor feedback circuitry 30a.

Referring again to FIG. 14, a method of operation of the curing light device or curing system according to one embodiment is generally designated 500. The method 500 may be implemented as a control module in the controller 126 using feedback based on one or more parameters or characteristics, namely radiation emitted from the target surface, and optionally one or more sense characteristics of the curing light device 114. In the illustrated embodiment, the method 500 includes initiating a cure operation 502 followed by setting the effective cure time (ECT) to 0 seconds (504). The controller 126 then measures the initial tooth temperature (Tinit) (506). After the initial tooth temperature (Tinit) is measured (508), controller 126 instructs the drive circuitry 128 to power the light source 124 according to an initial setting, such as a preselected source power level, thereby starting application of light to the targeted surface (508). Controller 126 then measures the present tooth temperature (Tp) (510). After measuring the tooth present temperature (510), controller 126 compares the measured present temperature (Tp) to the initial tooth temperature (Tinit) and determines whether the change in temperature (TΔ) is greater than a threshold level, such as a tooth temperature limit (512). If controller 126 determines that the change in temperature (TΔ) is less than the tooth temperature limit, then controller 126 powers the light source, e.g. the LED light source, to its preset power (514). For example, the preset power may be in a range of about 1000 mW/cm² to 3000 mW/cm² or greater than about 2000 mW/cm².

The curing light device according to one embodiment is configured to cure a restorative compound by controlling light output during the cure cycle to achieve a target output, possibly specific to the curable material or restorative compound being used. For instance, the operator may utilize an operator interface, such as operator interface 122 (similar to interface 22 in FIGS. 1 and 2), to select a target cure setting for a curing operation that is prescribed by a manufacturer of the curable material being used. In this way, the amount of light energy applied during a curing operation may be selectively chosen based the material being used rather than “over-curing” the curable material by a factor of two or three to eliminate a potential under-cure due to distance, angle, or other external variation factors. If curing intensity levels are considered low (e.g., 200 to 300 mW/cm²), intentional over-curing a curable material by a factor of two or three to eliminate a potential under-cure due to distance, angle, or other external variation factors is often not considered to be an issue. However, with use of curable materials that prescribe higher cure energies, and therefore a higher energy curing light device (e.g., an instrument that produces at least 1000 mW/cm² and possibly up to 3000 mW/cm² or more), intentional over-curing can result in application of energy that is an order of magnitude greater than that of direct sunlight (e.g., 100 mW/cm²). The curing light device in the illustrated embodiment of FIGS. 12 and 13 utilizes feedback based on the temperature of the target and optionally based on light reflected from the target to control the delivery of light energy, thereby substantially avoiding significant over-curing and intentional over-curing procedures that generate light energies two to three times the prescribed amount.

In the illustrated embodiment, the controller may be configured to track and manage the effective cure time (ECT) during the curing process to assure proper curing. Further, the controller may be configured to adjust the effect cure time (ECT) to compensate for the reduced output from the light source, as will be described below. In the illustrated embodiment, controller 126 increases the effect cure time (ECT) stored in memory by a preselected period of time X, for example, by a tenth of a second, by adding a value (X) corresponding to the period of time to the ECT stored in the memory of controller 126 (516), which is initially set at zero when the curing process is initiated. As the curing process progresses, the ECT is increased by controller 126 either based on the actual time period or by a reduced time period as noted below. Further, controller 126 includes a timer, which is referenced by controller 126 to hold a wait to take further action until the period of time X has passed (518), for example 0.1 seconds (520).

After the period of time X (e.g. 0.1 seconds) has passed, controller 126 then compares the ECT value now stored in memory to the desired cured time (CT) (520). If the stored effective cure time (ECT) is less than the desired cure time (CT), the controller 126 again measures the current tooth temperature (Tp) (510). This is repeated until, either the stored effective cure time (ECT) is greater than the desired cure time (CT), in which case controller 126 will turn off the power to the light source, e.g. the LED light source (526), and the curing process is terminated at 128.

However, if at step 512, controller 126 determines that the change in tooth temperature (TΔ) is greater than the temperature limit, then controller 126 reduces the power to the light source (522) and, further, adds to the effective cure time (ECT) stored in memory a value Y that represents some value, less than preselected time period X, for example a percentage of X (524).

In the illustrated embodiment, controller 126 greatly reduces the power to the light source to avoid overheating. The reduction is dependent on a number of variables, including the preset power, the size of the target (e.g. tooth) is, etc. So, for example, for a higher preset power, for example, in a range of 2000 mW/cm²-3000 mW/cm² or greater, the reduction may be in a range of about 40% to 5% reduction, whereas for preset power in a range of 1000-1500 mW/cm², the reduction may be in a range of about 60% to 30%. Overall the reduction may fall in a range of about 60% to 5%, optionally in a range of about 50% to 10%, optionally in a range of about 40% to 15%, and optionally about 20%. Similarly, the value Y may be in a range 60% to 5%, of X, optionally in a range of about 50% to 10% of X, optionally in a range of about 40% to 15% of X, and optionally about 20% of X.

After controller 126 has increased the stored value for the effective cure time (ECT), controller 126 will again wait for a period of X seconds (518) (e.g. 0.1 seconds), and thereafter compare the stored value of the ECT to the desired cure time (CT) (520).

If the stored effective cure time is less than the desired cure time, then controller 126 will again measure the present or current tooth temperature at 510 and repeat steps 514, 516 or 522 and 524 described above. If at 520, as noted above, controller 126 determines that the effective cure time (ECT) is greater than the desired cure time (CT), then controller 126 will no longer supply power to the light source (124) and terminate the curing process at 528.

For purposes of disclosure, the present disclosure includes several embodiments that implement such control-based delivery of light to a curable material. However, it should be understood that the present disclosure is not limited to the specific constructions and embodiments described herein, and that essentially any controlled curing instrument is contemplated. For additional details not provided herein, reference is made to U.S. patent application Ser. No. 14/857,273 (P-111A) and 62/415,592 (P117), which are incorporated by reference herein in their entireties.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements or configurations, illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A curing light assembly comprising:
a housing;
a base for supporting said housing in a storage position;
a light source supported by said housing;
a controller configured to operate said light source;
a light sensor in communication with said controller, said light sensor being operable to detect light emitted from said light source when said housing is supported in said storage position, and said controller configured to calibrate said light source based on light detected by said light sensor from said light source when said housing is supported in said storage position.

2. The curing light assembly according to claim 1, wherein said light sensor is supported by said housing, and said light sensor being operable to detect a reflection of light emitted from said light source.

3. The curing light assembly according to claim 2, wherein said base is configured to support said curing light assembly on a surface, and said light sensor being operable to detect a reflection of light emitted from said light source from the surface.

4. The curing light assembly according to claim 2, wherein said base includes a reflective surface, and said light sensor being operable to detect a reflection of light emitted from said light source from said reflective surface.

5. The curing light assembly according to claim 1, wherein said controller is supported in said housing.

6. The curing light assembly according to claim 1, further comprising an actuatable input device in communication with said controller, and said controller being configured to initiate calibration of said light source in response to actuation of said actuatable input device.

7. The curing light assembly according to claim 6, wherein said actuatable input device comprises a user actuatable input device.

8. The curing light assembly according to claim 7, wherein said user actuatable input device comprises a user actuatable switch.

9. The curing light assembly according to claim 6, wherein said actuatable input device is supported by said housing or said base.

10. The curing light assembly according to claim 9, wherein said actuatable input device comprises a sensor.

11. The curing light assembly according to claim 10, wherein said sensor is operable to detect when said housing is supported in said storage position.

12. The curing light assembly according to claim 6, wherein said actuatable input device is supported by a handheld remote control device.

13. The curing light assembly according to claim 1 wherein said controller is further configured to vary, based on the light energy characteristic sensed by the light sensor from a target with a light curable material when the light from the light source is directed to the target, an operating characteristic of the light source to affect the light energy being output from the light source to the target.

14. The curing light assembly according to claim 1 further comprising a temperature sensor in communication with said controller, and said controller further configured to control an operating characteristic of the light source based on a temperature sensor feedback signal from the temperature sensor.

15. A method of calibrating a curing light device, the curing light device having a light source, said method comprising:
locating the curing light device in a storage position;
powering the light source of the curing light device when the light source is located in the storage position to emit light;
calibrating the light source based on the light emitted from the light source when the curing light device is in the storage position.

16. The method according to claim 15, wherein powering the light source includes powering the light source in response to a signal.

17. The method according to claim 15, wherein powering the light source in response to a signal includes powering the light source in response a signal from a sensor.

18. The method according to claim 15, wherein powering the light source in response to a signal includes powering the light source in response a signal from a switch.
